(19) United States
(12) Patent Application Publication
(10) Pub. No.: US 2020/0247250 A1
(43) Pub. Date: Aug. 6, 2020

(54) WIRELESS POWER TRANSFER SYSTEMS FOR ELECTRIC VEHICLES

(71) Applicant: Mahle International GmbH, Stuttgart (DE)

(72) Inventors: Francisco Gonzales Espin, Elche (ES); Christopher Laemmle, Stuttgart (DE); Daniel Deischl, Nagold (DE)

(21) Appl. No.: 16/782,056

(22) Filed: Feb. 4, 2020

(30) Foreign Application Priority Data
Feb. 5, 2019 (EP) 19382083.4

(51) Int. Cl. B60L 53/122; B60L 53/22; H02J 50/12; H02M 1/42; H04B 5/00

(52) U.S. Cl. CPC B60L 53/122; B60L 53/22; H04B 5/0093; H02M 1/4208; H04B 5/0037; H02J 50/12

(57) ABSTRACT

A wireless power transfer (WPT) system for an electrical vehicle (EV) may include a ground assembly (GA) having a GA transmitter coil, a vehicle assembly (VA) having a VA receiver coil magnetically coupled to the GA transmitter coil, a compensation strategy stage including a parallel-series compensation network to obtain a voltage V_{VA} in the VA receiver coil proportional to an effective current I_{p_rms} in the GA transmitter coil, a rectifier in the VA to obtain a continuous voltage V_{dc_VA}, and a control strategy stage with a voltage control loop and a current control loop. The control strategy stage may provide a control command to regulate voltage in the VA to adjust the continuous voltage V_{dc_VA} based on a reference DC link voltage. A DC link of a conductive charger of the EV may be regulated with the adjusted continuous voltage V_{dc_VA} during an inductive charging process of the EV. The rectifier may be connected to the DC link of the conductive charger of the EV.

The present invention refers to wireless power transfer systems for electric vehicles (EV).

### BACKGROUND OF THE INVENTION

Wireless power transfer (WPT) using magnetic resonance is the technology which could set humans free from the annoying wires. In fact, the WPT adopts the same basic theory which has already been developed for at least 30 years with the term inductive power transfer. WPT technology has been developing rapidly in recent years. At kilowatts power level, the transfer distance increases from several millimeters to several hundred millimeters with a grid to load efficiency above 90%. The advances make the WPT very attractive to the electric vehicle (EV) charging applications in both stationary and dynamic charging scenarios. By introducing WPT in EVs, the obstacles of charging time, range, and cost can be easily mitigated and battery technology is not as relevant in the EVs market.

Conventionally, in power conversion, when AC is converted to low voltage DC, or AC from one frequency to another, the AC is usually rectified and smoothed to obtain a fixed voltage at fixed frequency. Once this is accomplished, the power is then routed to an inverter to obtain the final output with variable voltage and variable frequency. The DC voltage that is fed into the inverter is called the DC link. As the name implies, the two sources are linked together with a filter capacitor.

In electric vehicle (EV) applications, the DC link capacitor is used as a load-balancing energy storage device. The DC link capacitor may be placed between the DC battery and the AC, i.e. the load side of the voltage inverter. The capacitor is placed parallel to the battery and to a DC-to-DC battery charger, maintaining a solid voltage across the inverter. The DC link capacitor helps protecting the inverter network from momentary voltage spikes, surges and EMI.

A known WPT system (100) for an EV (120) is shown in FIG. 1, where the basic functional blocks for inductive charging are shared between a ground assembly (GA) (101) and a vehicle assembly (VA) (102).

The GA (101) of the WPT system (100) comprises an AC/DC converter (104) with power factor correction (PFC) that converts the single or three phase power source (103) to a regulated DC power source. The GA (101) of the WPT system (100) also comprises a DC to high frequency (HF) AC converter (105) that generates a square wave voltage with a nearly constant frequency and duty cycles. The GA (101) comprises a primary compensation circuit (106) which is a passive circuit network that compensates the transmitting coil inductance in order to reduce the amount of reactive power delivered by the DC to HF AC converter (105).

The WPT system (100) comprises an inductive charging coil assembly (112) comprising a transmitting GA coil (107) in the ground side, GA (101) and a receiving VA coil (108) located at the vehicle side, VA (102).

The VA (102) comprises a secondary compensation circuit (109) which is a passive circuit network that compensates the receiving coil inductance in order to maximize the transferred power at electrical resonance. The VA (102) comprises an AC/DC Rectifier (110) and/or a DC/DC battery charger (205) (shown in FIG. 2)(that may or may not include battery charging algorithms/charging strategy) and the high voltage battery (111).

The charging of the high voltage battery (111) can potentially be handled by both assemblies the GA (101) and the VA (102) of the WPT system (100), which design can determine an optimal WPT architecture.

Typically, the VA inductive charging of the WPT systems is designed without considering the potential existing conductive charger in the EV. Therefore the charging modules in the WPT are not optimized in terms of cost, volume and weight, because some of the basic functionalities of the charging modules in the VA (102) are likely to be duplicated in the conductive and inductive charging stages of the EV (120).

For instance, existing systems elements of the inductive charger of the VA as e.g. a current-doubler rectifier, an interleaved secondary control and/or an output filter stages may not be shared with the conductive charger of the VA. In these systems, it is likely that a conductive on-board charger (OBC) is connected in parallel to the battery duplicating the functionality of the aforementioned stages as shown in FIG. 2 that shows the conductive charging stage of the EV (120).

FIG. 2 shows again, the WPT system (100) in combination with a conductive charging stage OBC (200) in the EV (120). The WPT system (100) comprises the GA (101) with the AC/DC converter (104) with power factor correction (PFC) that converts the three phase power source (103) to a regulated DC power source, the HF AC converter (105) that generates a square wave voltage, the primary compensation circuit (106) to compensate the transmitting coil inductance and the transmitting coil (107).

The VA (102) of the WPT system (100) comprises the receiving VA coil (108) located at the vehicle side of the inductive charging coil assembly (112), the secondary compensation circuit (109) to compensate the receiving coil inductance, the AC/DC Rectifier (110), a DC link capacitor (204) and a DC/DC battery charger (205).

FIG. 2 shows the OBC (200) for conductive charging of the EV (120). The OBC (200) of the VA (102) comprises a three phase PFC stage (201) for the three phase power source (103), a DC link comprising a DC link capacitor (202) and an isolated DC/DC battery charger (203).

Hence, it can be seen from FIG. 2 that the DC link capacitors (204) and (202) of the inductive VA (102) and the OBC (200), as well as the DC/DC battery chargers (205) and (203) are duplicated.

Therefore, a battery charging system that uses inductive and conductive charging but avoids at least the aforementioned duplicities to reduce volume, weight and cost of the vehicle assembly of the EV is desired.

### DESCRIPTION OF THE INVENTION

This invention deals with a wireless power transfer (WPT) system that can be integrated with an already existing conductive on-board battery charger (OBC) for electric vehicles. The invention has the potential of sharing the conductive on-board charger modules with the WPT system, thus reducing volume, weight and cost of the vehicle assembly.

This invention proposes a WPT architecture including the associated power converter topologies with proposed compensation and control strategies that allow integrating the WPT system with charging modules of an already existing conductive charging system in the EV, thus optimizing the EV volume, weight and cost.

In a first aspect, it is proposed an example of a WPT system for an EV according to the present invention. The WPT system comprises a GA and a VA. The GA comprises a GA transmitter coil and the VA comprises a VA receiver coil magnetically coupled to the GA transmitter coil. This WPT system can correspond to FIGS. 3 and 4.

The WPT comprises a compensation strategy. The compensation strategy comprises a parallel-series compensation network that permits obtaining a voltage V_{VA} in the VA receiver coil which amplitude is proportional to an effective current I_{p_rms} flowing through the GA transmitter coil. A parallel-series compensation network is shown in FIG. 5.

The voltage V_{VA} in the VA receiver coil can be converted into a continuous voltage with a rectifier comprised in the VA of the EV. Hence, a continuous V_{dc_VA} of the voltage source V_{VA} is obtained in the VA receiver coil of the WPT.

The WPT comprises a control strategy stage to adjust the continuous voltage V_{dc_VA} in order to reach a reference DC link voltage. For this action, the control strategy stage comprises two nested control loops: a voltage control loop receiving as inputs the continuous V_{dc_VA} and the reference DC link voltage and a current control loop receiving as inputs the current I_{p_rms} and the output of the voltage control loop. The reference DC link voltage is the required voltage in the DC link of the conductive charger of the EV.

Hence, the DC link of the conductive charger of the EV can be regulated with the adjusted V_{dc_VA} during an inductive charging process of the EV. Therefore, upon the use of the proposed compensation and control strategies, the proposed WPT can use the battery charging modules/DC link of the conductive charger during an inductive charging process of the EV and hence, duplicities in the vehicle assembly can be avoided.

The GA of the WPT can comprise a DC-to-AC converter that converts a DC source to a square wave voltage source. A duty cycle of the DC-to-AC converter may vary depending upon a control command received from the control strategy stage to obtain the adjusted V_{dc_VA}.

Additionally, the WPT comprises a DC blocking and impedance matching network (IMN) stage that comprises a capacitor Cc for blocking DC current that may saturate an IMN transformer. An inductor Lc can convert the square wave voltage source from the DC-to-AC converter to a current source. The IMN transformer can adapt the impedance and voltage levels to values required by the GA coil and the VA coil in the WPT.

In a second aspect, it is proposed another example of a WPT system for an EV. The WPT comprises a GA and a VA. The GA comprises a GA transmitter coil. The VA comprises a VA receiver coil magnetically coupled to the GA transmitter coil.

This WPT also comprises a compensation strategy that comprises a parallel-series compensation network to obtain a voltage V_{VA} in the VA receiver coil proportional to an effective current I_{p_rms} in the GA transmitter coil.

The WPT also comprises a control strategy stage to adjust V_{dc_VA} based on the reference DC link voltage. As in the first WPT, the reference DC link voltage is the required voltage in the DC link of the conductive charger of the EV.

The control strategy stage comprises two nested control loops: a voltage control loop receiving the V_{dc_VA} and the reference DC link voltage as inputs and a current control loop receiving the current I_{p_rms} and an output from the voltage control loop.

A power factor correction (PFC) stage of a conductive charger of the EV can be supplied with V_{VA} during an inductive charging process of the EV to obtain a continuous V_{dc_VA}. Hence, the continuous V_{dc_VA} can be used to regulate a DC link of the conductive charger of the EV. Therefore, the proposed second example of WPT uses the battery charging modules/DC link of the conductive charger during an inductive charging process. Furthermore, this WPT also uses the PFC of the conductive charger as a rectifier to obtain the continuous V_{dc_VA}. Hence, DC charging stages of a conventional WPT are no longer needed with the proposed WPT. The WPT of the second aspect according to the present invention can correspond to the embodiment shown in FIG. 7.

Similar to the first aspect, WPT comprises the DC-to-AC converter regulated with a control command of the control strategy stage to obtain the adjusted V_{dc_VA} and a DC blocking and impedance matching network (IMN).

In a third aspect according to the present invention, it is proposed an electrical vehicle that comprises a conductive charging stage having a DC link and the proposed WPT.

In a fourth aspect, it is proposed a method for charging an EV with a WPT system according to the present invention, the system comprising a GA and a VA, the method comprises a step for applying an effective current I_{p_rms} to a GA transmitter coil of the WPT, a second step for obtaining a voltage V_{VA} in a VA receiver coil of the WPT proportional to the I_{p_rms}, a third step for obtaining a continuous voltage V_{dc_VA} in the VA of the WPT, a fourth step for adjusting V_{dc_VA} to reach a reference DC link voltage value, a fifth step for regulating a DC link of a conductive charging of the EV with the adjusted V_{dc_VA}. This method may be performed by the WTP according to the first WPT described in the present disclosure.

In a fifth aspect, it is proposed a method for charging an EV with a WPT system, the system comprising a GA and a VA, the method comprises a first step for applying a effective current I_{p_rms} to a GA transmitter coil of the WPT, a second step for obtaining a voltage V_{VA} in a VA receiver coil of the WPT proportional to the I_{p_rms}, a third step for adjusting V_{dc_VA} to reach a reference DC link voltage, a fourth step for supplying a PFC of conductive charger of the EV with the V_{VA} to obtain a continuous adjusted V_{dc_VA}, and a fifth step for regulating a DC link of the conductive charging of the EV with the continuous adjusted V_{dc_VA}. This method may be performed by the second WTP described in the present disclosure.

### BRIEF DESCRIPTION OF THE DRAWINGS

For a better understanding the above explanation and for the sole purpose of providing an example, some non-limiting drawings are included that schematically depict a practical embodiment.

FIG. 1 shows a conventional WPT system for an EV.

FIG. 2 shows a conventional WPT system in combination with a conductive charger of an EV.

FIG. 3 shows a first example of a WPT and a conductive charger according to the present invention.

FIG. 4 shows the first example of the WPT according to the present invention.

FIG. 5 shows an example of a parallel-series compensation network.

FIG. 6 shows the behavior of coupled coils.

FIG. 7 shows a second example of a WPT according to the present invention.

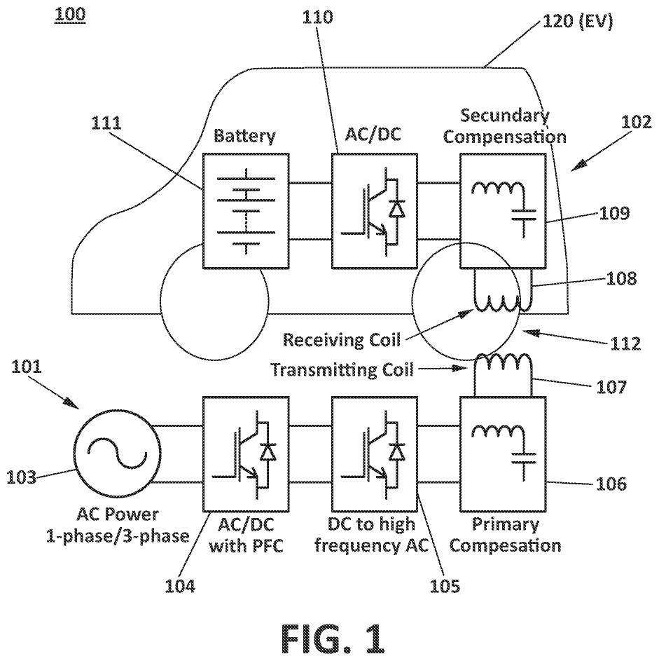

### DESCRIPTION OF A PREFERRED EMBODIMENT

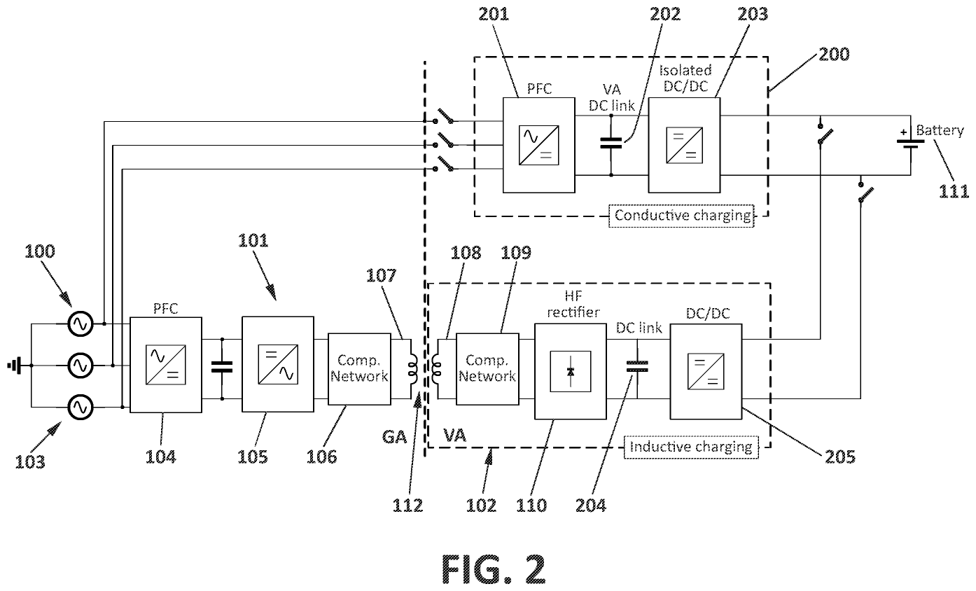

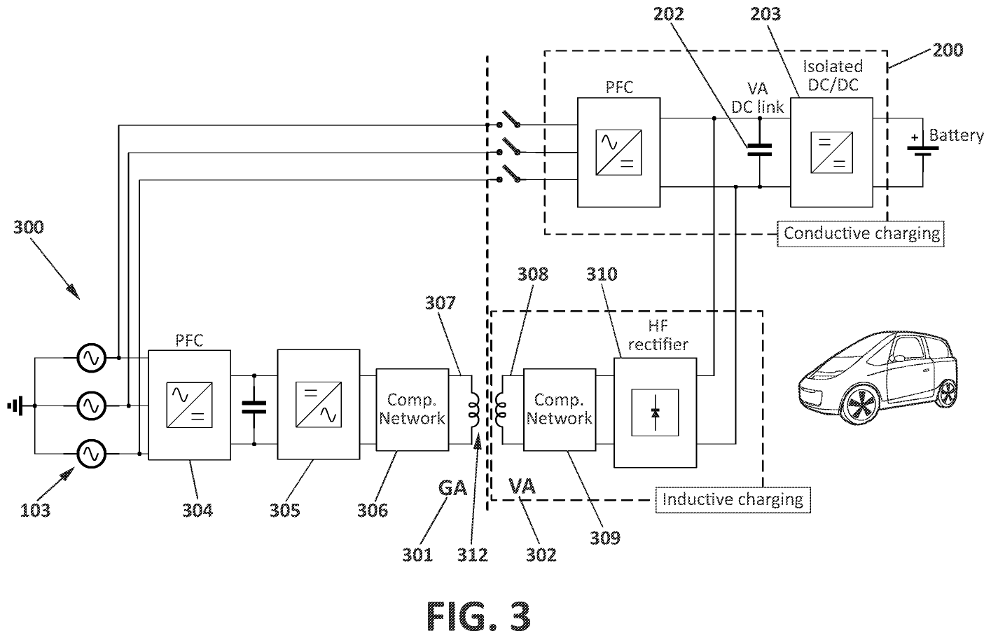

FIG. 3 shows a first example of a WPT system (300) according to the present invention in combination with a conductive charging stage that comprises the OBC (200) with the DC link capacitor (202) for an EV. The WPT system (300) comprises a GA (301) and a VA (302) for inductive charging of the EV. Furthermore, the EV comprises an OBC (200) for conductive charging as the one shown in FIG. 2.

The WPT system (300) comprises an inductive charging coil assembly (312) comprising a transmitting coil (307) in the GA (301) and a receiving coil (308) in the VA (302).

The GA (301) of the WPT system (300) comprises an AC/DC converter (304) with power factor correction (PFC) that converts the three phase power source (303) to a regulated DC power source. The GA (301) of the WPT system (300) comprises an AC converter (305) generates a square wave voltage with a nearly constant frequency and duty cycles.

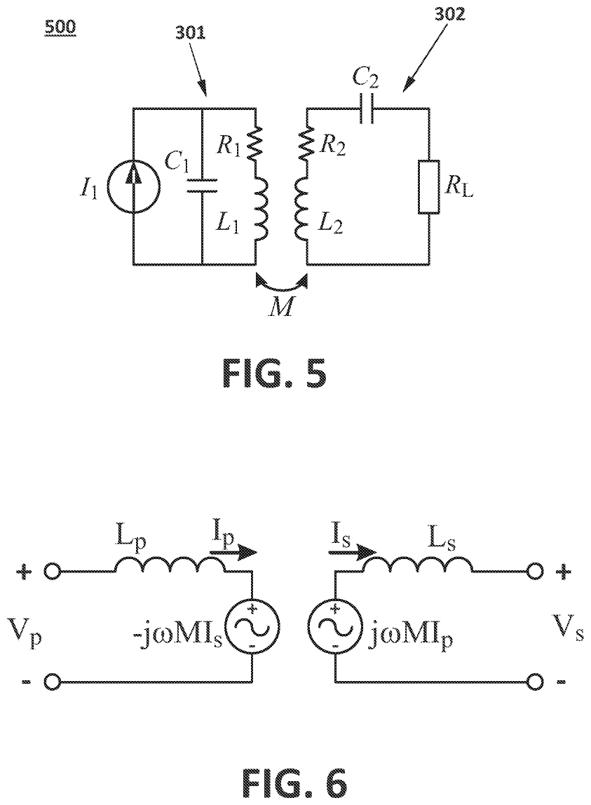

The WPT system (300) further comprises a compensation circuit having a primary compensation circuit (306) for the GA (301) and a secondary compensation circuit (309) for the VA (302). The compensation circuit is a parallel-series compensation network used to achieve a proposed compensation strategy according to the present invention. The proposed compensation strategy permits the inductive charging of the EV in the VA (302) to take advantage of the conductive battery charger by regulating the DC link voltage of the DC link capacitor (202) in the OBC (200). Hence, the compensation circuit (309) permits the receiving coil (308) to behave as a voltage source. Hence, a voltage V_{VA} is generated in the VA receiver coil (308) having an amplitude proportional to an effective current I_{p_rms} in the GA transmitting coil (307). A preferred parallel-series compensation network is shown in FIG. 5.

The VA (302) of the WPT system (300) comprises a secondary compensation circuit (309) as part of the parallel-series compensation network which causes the receiving coil (308) of the coil assembly (312) to behave as a voltage source. The VA (302) of the WTP system (300) lacks the DC link capacitor and the DC/DC battery charger previously shown in FIG. 2. The output of the HF rectifier (310) can be loaded in the DC link capacitor (202). Hence, the DC link capacitor (202) and the DC/DC battery charger (203) of the OBC (200) can be shared between the conductive stage OBC (200) and the VA (302) of the WPT system (300). Therefore, the proposed WPT system (300) avoids duplicities of the charging modules/DC links in the EV (120).

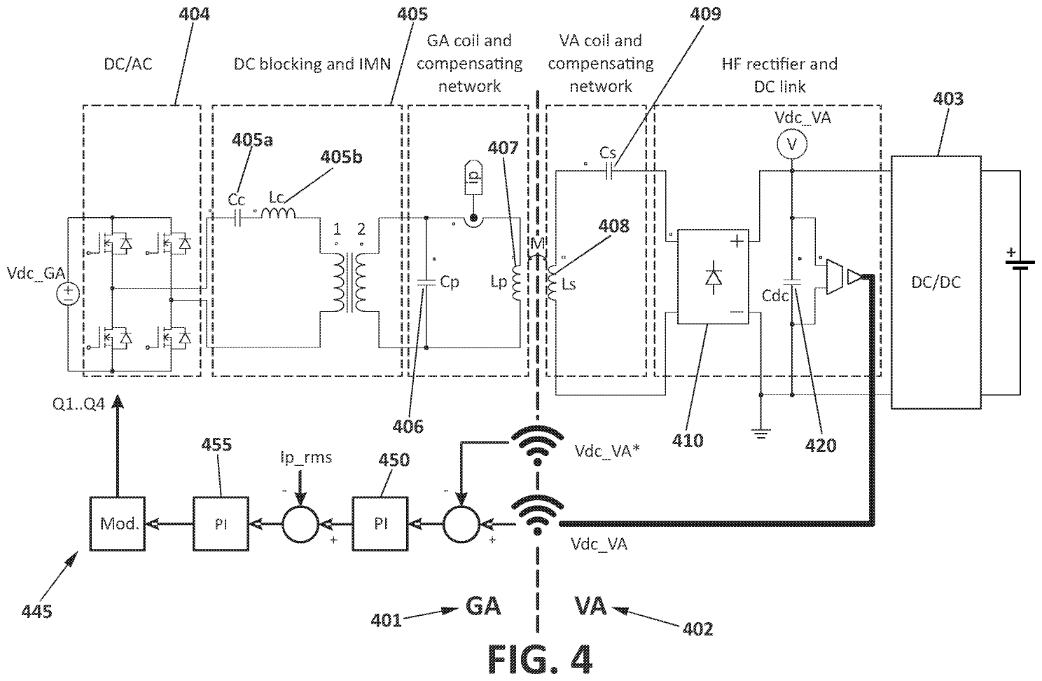

FIG. 4 shows a GA (401) and VA (401) wireless charging stages of a more detailed example of a WPT (400) according to the present disclosure. FIG. 4 also shows the control strategy stage (445) used to obtain a desired voltage to regulate a DC link/battery charger in a conventional conductive charger of an EV.

The GA (401) comprises a DC-to-AC converter (404) that would correspond to the AC converter (305) in FIG. 3 and which converts a DC source V_{dc_GA} to a square wave voltage source which main frequency depends upon an applicable technical standard, e.g. SAE standard (e.g. 81.38 kHz to 90 kHz), and which duty cycle may vary depending upon regulation circuit input command from the control strategy stage (445). The DC-to-AC converter (404) can be designed to minimize switching loses by means of zero voltage switching (ZVS) or zero current switching (ZCS) techniques.

The GA (401) comprises DC blocking and Impedance Matching Network (IMN) stage (405) that includes a capacitor Cc (405a) for blocking DC current that may saturate the IMN transformer. An inductor Lc (405b) converts the square wave voltage source to a current source and an IMN transformer adapts the impedance and voltage levels to values required by the WPT coils (407), (408).

The GA (401) comprises a GA coil Lp (407) and a primary compensating network (406). The VA (402) comprises a VA coil Ls (408) and a secondary compensating network (409). The compensation network (406), (409) is a parallel-series compensation circuit. As previously mentioned, the parallel-series compensation circuit advantageously permits to generate a voltage source V_{VA} at the VA coil Ls (408) which amplitude depends upon the effective current I_{p_rms} flowing through the GA coil Lp (407). Because the DC link voltage of the conductive charging in the DC/DC battery charge (403) shall be regulated within certain boundaries to ensure the proper operation of the on-board DC-to-DC battery charger, the parallel-series compensation circuit permits regulating the DC link voltage by controlling the GA coil current I_{p_rms} in the GA (401).

Hence, the GA coil Lp (407) transfers energy from the GA (401) to the VA (402). The compensating network (406) allows the reactive power to be locally provided (i.e. the DC-to-AC converter (404) delivers only the active power). The VA coil Ls (408) is magnetically coupled with the GA coil Lp (407) and receives the energy transferred wirelessly from the GA coil Lp (407) which is maximized.

The VA (402) comprises a HF rectifier (410). The HF rectifier (410) converts the high frequency signal across the VA coil to DC. FIG. 4 also shows a DC link capacitor Cdc (420) of the conductive charging of the EV. The WPT (400) also shows a block diagram of the proposed control strategy stage (445) used to obtain a desired continuous voltage that regulates the DC link/battery charger in the conductive charger of the EV.

As shown in FIG. 4, the control strategy stage (445) is composed of 2 nested control loops based on the regulation of the voltage source V_{dc_VA} and the GA coil current I_{p_rms}. For this particular implementation, the control strategy stage comprises two PI regulators (450), (455) for the voltage and current control.

V_{da_VA*} represents the reference DC link voltage, i.e. the required DC link voltage in the DC link. V_{dc_VA} is the actual DC link voltage, i.e. the voltage measured in real time. V_{dc_VA} is the DC value of the voltage V_{VA} at the VA coil Ls (408) after rectification. Furthermore, the WPT (400) comprises wireless communication means between the VA (402) and the GA (401). Hence, the reference DC link voltage V_{da_VA*} and the actual DC link voltage V_{dc_VA} can be sent from the VA (402) to the GA (401) wirelessly by using online communication as e.g. WIFI and/or offline communication as e.g. Bluetooth, NFC or the like. After some time (usually in the range of seconds or milliseconds for this application), the PI regulators (450), (455) can make the actual DC link voltage V_{dc_VA} equal to the reference DC link voltage V_{da_VA*}. Therefore the subtraction of V_{dc_VA} and V_{da_VA*} is 0 at steady state and the DC link of the conductive charger of the EV can be regulated with the adjusted V_{dc_VA} during an inductive charging process of the EV. Hence, the control strategy stage (445) can command the DC-to-AC converter (404) to regulate I_{p_rms} to obtain a V_{dc_VA} equal to V_{da_VA*}.

FIG. 5 shows a parallel-series compensation circuit (500) that can be used in the proposed WPT's according to the present invention. The VA coil model in the VA (302) includes a parasitic R2 and an inductor L2. If a capacitor C2 is placed in series with the inductor L2 (compensation network) and its value is properly chosen, the impedance of the series connection of L2 and the capacitor C2 is null at the operating frequency, where the wireless transfer happens at a fixed frequency f=85 Khz.

Interestingly enough, the amplitude of this voltage depends upon the signal frequency which is constant, the coupling term, M which is also constant for a given position of the EV car relative to the GA coil L1, and the GA current I_{p_rms}. Therefore, this is the electrical relationship between the GA coil current I_{p_rms} and the VA coil voltage V_{VA}. Therefore, as the inductor L2 is cancelled out with the series capacitor C2, this voltage V_{VA} can be placed directly across the terminals of the HF rectifier (410).

FIG. 6 explains the electrical behaviour of coupled coils. In this figure, a voltage source in series with the coil inductance is shown, which models more accurately the behaviour of the coupled coils (the parasitic resistance has been neglected in this figure). The compensation of the VA coil makes Lₛ to disappear from the model, thus leaving just the voltage source, which is proportional to the frequency, the coupling term M and the primary coil current Iₚ.

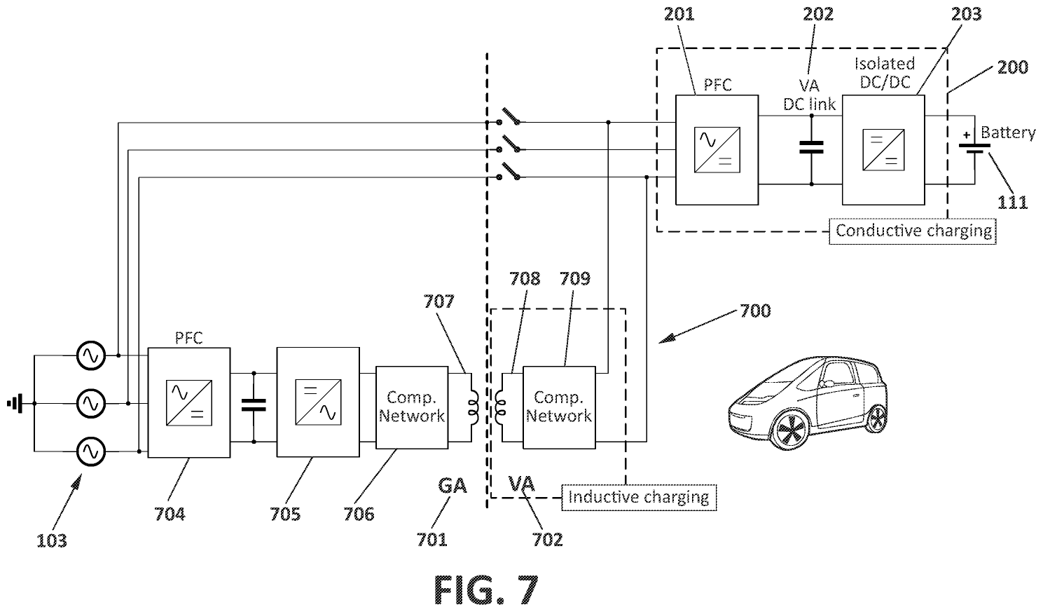

FIG. 7 shows an alternative example of a WPT (700) according to the present invention.

Similarly, the GA (701) of the WPT (700) comprises an AC/DC converter (704) with power factor correction (PFC) that converts the three phase power source (103) to a regulated DC power source. The GA (701) of the WPT (700) comprises an AC converter (705) that generates a square wave voltage with a nearly constant frequency and duty cycles.

The WPT (700) comprises an inductive charging coil assembly (712) comprising a transmitting coil (707) in the GA (701) and a receiving coil (708) in the VA (713).

The inductive charging coil assembly (712) in the GA (701) comprises a GA coil (707) and a primary compensating network (706). The VA (702) comprises the VA coil (708) and a secondary compensating network (709). The compensation network (706), (709) is also a parallel-series compensation circuit. As previously mentioned, the parallel-series compensation circuit advantageously permits to generate a voltage source at the VA coil (708) which amplitude depends upon the effective current flowing through the GA coil (707).

FIG. 7 also shows the conductive charging stage OBC (200) for conductive charging of the EV. The OBC (200) of the VA (702) comprises the three phase PFC stage (201) for the three phase power source (103), the DC link comprising the DC link capacitor (202) and the isolated DC/DC battery charger (203).

An alternative solution is shown in FIG. 7, the output of the VA compensation network (709) is connected to the input of the conductive charger three phase PFC stage (201) in the conductive charging OBC (200). Because the three phase PFC stage (201) can be composed of 3 half bridges based on MOSFETs (each of them including a parasitic body diode in parallel), the three phase PFC stage (201) stage can be used as a simple rectifier in order to obtain an adjusted continuous voltage (V_{dc_VA}) that can be used to regulate the DC link of the conductive charger of the EV during an inductive charging process of the EV, thus affording the dedicated rectifier shown in the original solution as well as the DC link.

Even though reference has been made to a specific embodiment of the invention, it is obvious for a person skilled in the art that the WPT architectures described herein are susceptible to numerous variations and modifications, and that all the details mentioned can be substituted for other technically equivalent ones without departing from the scope of protection defined by the attached claims.

1. A wireless power transfer (WPT) system for an electrical vehicle (EV), the system comprising:
a ground assembly (GA) having a GA transmitter coil;
a vehicle assembly (VA) having a VA receiver coil magnetically coupled to the GA transmitter coil;
a compensation strategy stage including a parallel-series compensation network to obtain a voltage V_{VA} in the VA receiver coil proportional to an effective current I_{p_rms} in the GA transmitter coil;
a rectifier in the VA to obtain a continuous voltage V_{dc_VA}; and
a control strategy stage with a voltage control loop and a current control loop;
wherein the control strategy stage provides a control command to regulate voltage in the VA to adjust the continuous voltage V_{dc_VA} based on a reference DC link voltage;
wherein a DC link of a conductive charger of the EV is regulated with the adjusted continuous voltage V_{dc_VA} during an inductive charging process of the EV; and
wherein the rectifier is connected to the DC link of the conductive charger of the EV.

2. The WPT system for an EV according to claim 1, wherein the GA comprises a DC-to-AC converter regulated with the control command of the control strategy stage.

3. The WPT system for an EV according to claim 1, wherein the GA comprises an AC/DC converter with power factor correction (PFC).

4. The WPT system for an EV according to claim 1, wherein the GA comprises a DC blocking and impedance matching network (IMN).

5. The WPT system for an EV according to claim 1, wherein the GA and the VA comprise wireless communicator for at least transmitting the continuous voltage V_{dc_VA} and the reference DC link voltage from the VA to the GA.

6. A wireless power transfer (WPT) system system for an EV, the system comprising:
a ground assembly (GA) having a GA transmitter coil;
a vehicle assembly (VA) having a VA receiver coil magnetically coupled to the GA transmitter coil
a compensation strategy including a parallel-series compensation network to obtain a voltage V_{VA} in the VA receiver coil proportional to an effective current I_{p_rms} in the GA transmitter coil; and
a control strategy stage with a voltage control loop and a current control loop;
wherein the control strategy stage provides a control command to regulate voltage in the VA to adjust a continuous voltage V_{dc_VA} based on a reference DC link voltage;
wherein a power factor correction (PFC) stage of a conductive charger of the EV is supplied with the voltage V_{VA} during an inductive charging process of the EV; and
wherein the continuous voltage V_{dc_VA} is the voltage measured at a DC link of the conductive charger of the EV.

7. The WPT system for an EV according to claim 5, wherein the GA comprises a DC-to-AC converter regulated with a control command of the control strategy stage.

8. The WPT system for an EV according to claim 5, wherein the GA comprises an AC/DC converter with PFC.

9. The WPT system for an EV according to claim 5, wherein the GA comprises a DC blocking and impedance matching network (IMN).

10. The WPT system for an EV according to claim 6, wherein the GA and the VA comprise wireless communicators for transmitting the continuous voltage V_{dc_VA} and the reference DC link voltage from the VA to the GA.

11. An electric vehicle, comprising:
a conductive charging stage having a DC link; and
a WPT system having:
a ground assembly (GA) having a GA transmitter coil;
a vehicle assembly (VA) having a VA receiver coil magnetically coupled to the GA transmitter coil;
a compensation strategy including a parallel-series compensation network to obtain a voltage V_{VA} in the VA receiver coil proportional to an effective current I_{p_rms} in the GA transmitter coil; and
a control strategy stage with a voltage control loop and a current control loop;
wherein the control strategy stage provides a control command to regulate voltage in the VA to adjust the continuous voltage V_{dc_VA} based on a reference DC link voltage;
wherein one of:
the WPT system further includes a rectifier in the VA to obtain a continuous voltage V_{dc_VA}, a DC link of a conductive charger of the EV is regulated with the adjusted continuous voltage V_{dc_VA} during an inductive charging process of the EV, and the rectifier is connected to the DC link of the conductive charger of the EV; or
a power factor correction (PFC) stage of a conductive charger of the EV is supplied with the voltage V_{VA} during an inductive charging process of the EV, and the continuous voltage V_{dc_VA} is the voltage measured at a DC link of the conductive charger of the EV; and
wherein the WPT system regulates the DC link of the conductive charging stage.

12. A method for charging an electric vehicle (EV) with a wireless power transfer (WPT) system having a ground assembly (GA) and a vehicle assembly (VA), the method comprising:
applying an effective current I_{p_rms} to a GA transmitter coil of the WPT system,
obtaining a voltage V_{VA} in a VA receiver coil of the WPT system proportional to the I_{p_rms};
obtaining a continuous voltage V_{dc_VA} in the VA of the WPT system;
adjusting the continuous voltage V_{dc_VA} based on a reference DC link voltage; and
regulating a DC link of a conductive charger of the EV with the adjusted continuous voltage V_{dc_VA}.

13. A method for charging an electric vehicle (EV) with a wireless power transfer (WPT) system having a ground assembly (GA) and a vehicle assembly (VA), the method comprising:
applying an effective current I_{p_rms} to a GA transmitter coil of the WPT system;
obtaining a voltage V_{VA} in a VA receiver coil of the WPT system proportional to the I_{p_rms};
supplying a power factor correction (PFC) stage of a conductive charger of the EV with the voltage V_{VA};
obtaining an adjusted continuous voltage V_{dc_VA};
adjusting the continuous voltage V_{dc_VA} based on a reference DC link voltage; and
regulating a DC link of the conductive charger of the EV with the adjusted continuous voltage V_{dc_VA};
wherein the continuous voltage V_{dc_VA} is the voltage measured at the DC link of the conductive charger of the EV; and
wherein the rectifier is connected to the DC link of the conductive charger of the EV.

14. The method according to claim 12, further comprising:
transmitting the continuous voltage V_{dc_VA} and the reference DC link voltage from the VA to the GA of the WPT systems.

15. The method according to claim 13, further comprising:
transmitting the continuous voltage V_{dc_VA} and the reference DC link voltage from the VA to the GA of the WPT systems.

16. The WPT system for an EV according to claim 6, wherein the GA comprises an AC/DC converter with PFC.

17. The WPT system for an EV according to claim 6, wherein the GA comprises a DC blocking and impedance matching network (IMN).

18. The WPT system for an EV according to claim 7, wherein the GA and the VA comprise wireless communicators for transmitting the continuous voltage V_{dc_VA} and the reference DC link voltage from the VA to the GA.

19. The WPT system for an EV according to claim 8, wherein the GA and the VA comprise wireless communicators for transmitting the continuous voltage V_{dc_VA} and the reference DC link voltage from the VA to the GA.

20. The WPT system for an EV according to claim 9, wherein the GA and the VA comprise wireless communicators for transmitting the continuous voltage V_{dc_VA} and the reference DC link voltage from the VA to the GA.
